(19) United States
(12) Patent Application Publication
(10) Pub. No.: US 2014/0287175 A1
(43) Pub. Date: Sep. 25, 2014

(54) PRODUCTS FOR STRESS CONTROL IN ELECTRICAL POWER CABLES

(71) Applicant: SHAWCOR LTD., Toronto (CA)

(72) Inventors: Sharon Elizabeth Krawiec, Mississauga (CA); Richard Valeriote, Guelph (CA); Douglas Neil Burwell, Georgetown (CA)

(73) Assignee: ShawCor Ltd., Toronto (CA)

(21) Appl. No.: 13/847,284

(22) Filed: Mar. 19, 2013

(51) Int. Cl. H01B 3/46

(52) U.S. Cl. CPC H01B 3/46
USPC 428/36.4; 428/447; 428/328

(57) ABSTRACT

A stress control article for protecting joints and terminations in electrical power cables and for controlling electrical stresses, comprises a cover layer comprised of an electrically insulating, flexible polymeric material; and a stress control layer applied to one side of the cover layer. The stress control layer comprises a stress control material which may comprise a particulate filler comprising varistor particles; and a polymer matrix in which the particulate filler is embedded. The polymer matrix may comprise a silicone gum.

### FIELD OF THE INVENTION

The invention relates to products for protecting joints and terminations in electrical power cables, and for controlling electrical stresses in such joints and terminations.

### BACKGROUND OF THE INVENTION

Joints and terminations in electrical power cables are typically protected from the surrounding environment by an electrically insulating layer of polymeric material, which can be in the form of a dimensionally unstable sleeve, or a tape, sheet or patch. However, such insulating layers are insufficient to control electrical stresses in medium and high voltage power cables, which typically operate at voltages in excess of about 5 kV.

The insulating jacket of a medium or high voltage cable is comprised of multiple layers which are successively cut back during preparation of a cable joint or termination. The cable conductor is typically surrounded by a conductor shield, which is covered by a layer of insulating material, and the insulating material is surrounded by an outer semi-conductive shield. Cutting back the semi-conductive shield causes a discontinuity in the electrical field, resulting in high stress at the cut end of the outer shield. The concentration of electrical stress at the end of the outer shield may cause electrical discharges which can damage the cable insulation.

The preparation of joints and terminations in medium and high voltage cables is usually performed by hand in the field, and is an arduous process. Care must be taken in cutting away the layers of the cable jacket so as not to produce deficiencies which could cause higher stresses at the end of the shield. For example, errant cuts in the layers of the jacket and a poorly shaped cut-back on the end of the outer shield can exacerbate the problems caused by electrical stresses.

It is known to use stress control means to control electrical stress in cable joints and terminations. For example, U.S. Pat. No. 6,340,794 to Wandmacher et al. describes a two-part system for electrical stress control comprising a non-tacky, void-filling conformable stress control material positioned at the shield cut edge of a power cable, with an elastomeric stress control tube provided over the stress control material. U.S. Pat. No. 6,124,549 to Kemp et al. discloses a protective sleeve comprising an outer heat shrinkable insulating layer and an inner stress control layer. Kemp et al. discloses that the stress control layer comprises a doped zinc oxide varistor powder embedded in a polymeric matrix. The varistor particles exhibit nonlinearity in respect of their electrical impedance, and also exhibit a switching behaviour, whereby there is an abrupt transition in the graph of voltage versus current, such that there is an abrupt drop in impedance in response to an increase in the electric field. The stress control layer must resist breakdown at high electrical stresses in order to protect the cable from damage.

In order to provide adequate stress control at a cable joint or termination the stress control layer must include a sufficiently high loading of filler particles, and must have void-filling properties so as to ensure that the material completely fills the step at the cut end of the outer shield. The existence of voids in the stress control layer may result in damaging electrical discharges.

The Applicants have found that it is difficult to achieve sufficiently high loading of filler particles in conventional matrix materials while preserving desirable void-filling properties, and have therefore recognized the need for improved stress control materials.

### SUMMARY OF THE INVENTION

In an embodiment, a stress control article for an electrical cable comprises: (a) a cover layer comprised of an electrically insulating, flexible polymeric material; and (b) a stress control layer applied to one side of the cover layer, wherein the stress control layer comprises a stress control material.

In an embodiment, the stress control material comprises: (i) a particulate filler comprising varistor particles; and (ii) a polymer matrix in which the particulate filler is embedded, wherein the polymer matrix comprises a silicone gum.

In an embodiment the silicone gum is a non-tacky, flowable silicone polymer comprised of siloxane repeating units having the general formula [—O—Si(R2)—], wherein each R group is independently selected from the group comprising alkyl groups, alkenyl groups and aryl groups, any of which may be substituted or unsubstituted. The alkyl groups may be selected from the group comprising methyl, ethyl and propyl groups, any of which may be substituted or unsubstituted. The alkenyl groups may comprise substituted or unsubstituted vinyl groups. The aryl groups may comprise substituted or unsubstituted phenyl groups.

In an embodiment, the silicone gum may be substantially free of crosslinks. For example, the silicone gum may comprise less than about 1 mol percent of crosslinkable functional groups, and/or the silicone gum comprises less than about 1 mol percent of said alkenyl groups.

In an embodiment, the R groups of the siloxane repeating units may consist essentially of methyl groups, such that the silicone gum consists essentially of a polydimethylsiloxane polymer and the repeating units in the polymer molecules making up the gum consist essentially of polydimethylsiloxane repeating units.

In an embodiment, the silicone gum may have a molecular weight ranging from about 370,000 to 740,000 and a degree of polymerization ranging from about 5,000 to 10,000.

In an embodiment, the amount of the particulate filler embedded in the polymer matrix ranges from about 60-90 wt. %, and/or the weight ratio of the particulate filler to the polymer matrix in the stress control material is from about 2:1 to about 4:1.

In an embodiment, the varistor particles comprise doped particles of ZnO. The varistor particles may have an average particle size of less than about 80 μm.

In an embodiment, the cover layer is a cold shrink tube, wherein the electrically insulating, flexible polymeric material of the cover layer comprises an elastomeric material, and wherein said one side of the cover layer to which the stress control layer is applied is an inner surface of the tube. For example, the elastomeric material may comprise silicone rubber. The stress control article may further comprise a removable, one-piece rigid spiral core received inside the cover layer, wherein the cover layer is maintained in a stretched state by the core.

In an embodiment, the stress control layer is applied over portions of the inner surface which, when the article is installed over a cable, will be in contact with those portions of a cable termination or joint which are subjected to the greatest electrical stresses.

In an embodiment, the cold shrink tube has two ends, and wherein each end of the tube is provided with a layer of a conformable water sealing mastic, wherein the layers of the conformable water sealing mastic are applied to the inner surface of the tube.

### BRIEF DESCRIPTION OF THE DRAWINGS

The invention will now be described, by way of example only, with reference to the accompanying drawings in which:

FIG. 1 is a perspective view showing the end of a cable prepared for termination;

FIG. 2 is a longitudinal cross-section along line 2-2 of FIG. 1;

FIG. 3 is a longitudinal cross-sectional view of a sleeve according to a first embodiment, prior to application to a cable;

FIG. 4 is a longitudinal cross-sectional view of the sleeve of FIG. 3, applied to the cable of FIGS. 1 and 2; and

FIG. 5 is a longitudinal cross-sectional view of a sleeve according to a second embodiment, applied to a joint between two cables.

### DETAILED DESCRIPTION

The embodiments of the invention specifically described herein relate to stress control articles for protecting and controlling electrical stresses in joints and terminations in electrical power cables, and more particularly in medium voltage electrical cables which usually operate at voltages in the range from about 5-35 kV. It will, however, be appreciated that the present invention may be adapted for use in electrical cables adapted to operate at voltages outside the above range, such as high voltage electrical cables operating at voltages greater than 35 kV.

Medium voltage cables include a conductor which is typically made of copper and which may be stranded or unstranded (solid). The conductor is enclosed within a jacket or sheath which is comprised of multiple layers, typically including (going outward from the conductor): a semi-conductive conductor screen, an electrically insulating (dielectric) plastic layer, an outer semi-conductive shield; a layer of copper wires or helically wound copper tape; and an outer protective layer comprised of an electrically insulating (dielectric) plastic.

When preparing a medium voltage cable for termination, the jacket must be stripped away to expose a bare end of the conductor, and each successive layer of the jacket must be cut back and stripped away to expose a portion of an immediately underlying layer of the cable. In a cable termination, a conductive metal lug may be applied over the exposed end of the conductor and secured in place by crimping or by alternate means such as by set screws, or soldering. In a cable joint, the exposed ends of the conductors being joined may be inserted into the opposite ends of a cylindrical metal connector and secured in place by crimping or the like.

The stress control articles according to the invention include a cover layer which is electrically insulating and is of sufficient size and shape to cover the entire joint or termination. In a termination, the cover layer is shaped and sized so that it overlaps the outer protective layer of the cable at one end and overlaps with the lug at the other end. In a cable joint, the cover layer is sized and shaped so that it overlaps with the outer protective layers of both cables being joined.

The cover layer may take a variety of forms, including a sheet, tape, patch, wraparound sleeve or hollow tubular sleeve. Where the cover layer comprises a hollow tubular sleeve it will be dimensionally unstable, and recoverable from a first diameter at which it can easily be slipped over the end(s) of the cable(s) being terminated or joined, to a second diameter at which it is in intimate contact with the cable.

For example, the cover layer may be a heat shrinkable tube or sleeve. In this case the cover layer may comprise a crosslinked, thermoset polymer which may be heated and stretched to the first diameter, and fixed in this stretched state by rapid cooling. Subsequent re-heating causes the cover layer to elastically recover to its original unstretched diameter, which may be somewhat smaller than the diameter of the cable, thereby ensuring a tight fit over the cable.

In the alternative, the cover layer may be a “cold shrink” tube or sleeve, in which case the tube or sleeve is made of an elastomeric material which is stretched to its first, expanded diameter and maintained in the expanded state by means such as a removable core, which may be a one-piece rigid spiral core having interconnected adjacent coils as described in U.S. Pat. No. 6,340,794 to Wandmacher et al. Removal of the core causes the tube or sleeve to shrink toward its original diameter, which may be somewhat smaller than the diameter of the cable, thereby ensuring a tight fit over the cable. Suitable elastomeric materials include silicone rubber or any other elastomeric material which possesses the ability to stretch and recover over the cable, and which has sufficient arc resistance, track resistance and UV resistance.

The stress control articles according to the invention also include a stress control layer applied to one side of the cover layer. The stress control layer is applied to the surface of the cover layer which will be in contact with the cable. In a tube or sleeve, the stress control layer is applied to the inner surface thereof, and is applied over a sufficient portion of the tube or sleeve so that the stress control layer will be in contact with those portions of the cable(s) which are subjected to the greatest electrical stresses.

In this regard, the highest electrical stresses tend to be concentrated at the cut end of the semi-conductive shield, due to a discontinuity in the electrical field caused by cutting back the outer shield. In the absence of a stress control layer these high stresses can cause electrical discharges at the end of the outer shield, which can eventually cause breakdown of the cable insulation. Therefore, the stress control layer is applied over a sufficient area of the tube or sleeve it will cover the cut end of the outer shield and those areas adjacent to the end of the shield.

The stress control layer comprises a stress control material comprising a particulate filler embedded in a polymer matrix. The particulate filler comprises varistor particles of doped metal oxide or carbide with predominantly spherical structure. For example, the varistor particles may comprise doped zinc oxide, doped tin oxide, doped silicon carbide, and mixtures thereof. More typically, the varistor particles comprise doped metal oxides which, in the specific embodiments described herein, comprise doped zinc oxide.

The varistor particles may be doped with oxides of bismuth, chromium, antimony, manganese, cobalt, aluminum, silicon, and/or mixtures thereof, and may include trace amounts of lead, iron, boron and/or aluminum. The doping of the particles provides them with capacitance, and the electrical properties of the varistor particles can be varied in a known manner by varying the dopants. For example, where the products according to the invention are intended for use for termination of medium voltage electrical cables, the “switching point” at which the varistor particles switch into a low resistance state may be in the range from about 400-600 V/mm, and the doping of the varistor particles can be adjusted in a known manner to provide the varistor particles with this switching point, or another desired switching point.

The particle size of the varistor particles ranges from about 10-200 μm, with greater than 90 vol. % of the varistor particles ranging from about 20-130 μm in diameter. For example, the sieve residue of particles having diameter greater than about 125 μm is less than about 3 wt. %.

The mean particle size of the varistor particles is less than about 100 μm, for example less than about 80 μm, and may be in the range from about 60-70 μm.

Varistor particles and their methods of production are disclosed in U.S. Pat. No. 6,469,611 to Kluge-Weiss et al., U.S. Pat. No. 7,651,636 to Gramespacher et al, and U.S. Pat. No. 7,868,732 to Hoidis et al., which are incorporated herein in their entireties. Varistor particles having electrical properties tailored for specific applications, including use in terminations and joints in medium voltage electrical cables, are commercially available and therefore their preparation is not described in detail herein.

The filler particles are embedded in a polymer matrix comprised of a non-tacky, flowable silicone polymer comprised of siloxane repeating units having the general formula [—O—Si(R₂)—] where each R group is independently selected from the group comprising alkyl groups, alkenyl groups and aryl groups, which may be substituted or unsubstituted. Representative alkyl groups include substituted or unsubstituted methyl, ethyl and/or propyl groups. Representative alkenyl groups include substituted or unsubstituted vinyl groups. Representative aryl groups included substituted or unsubstituted phenyl groups. For example, the siloxane repeating units of the silicone polymers may comprise dimethlysiloxane, phenylmethylsiloxane, diphenylsiloxane, methylvinylsiloxane, phenylvinylsiloxane and/or combinations thereof. For example, the silicone polymer may be a polydimethylsiloxane polymer in which the predominant siloxane repeating units are dimethylsiloxane groups.

The terminal groups of the silicone polymers are trisubstituted siloxy groups, wherein the substituents may be the same alkyl, alkenyl and/or aryl R groups described above. For example, where the silicone polymer comprises a polydimethylsiloxane polymer, the terminal groups may comprise trimethylsiloxy groups.

The silicone polymer is substantially uncrosslinked. Where the silicone polymer includes functional groups such as alkenyl groups, these groups may be free (unreacted) or crosslinked (reacted). For example, the silicone polymer may contain less than about 1 mol percent of crosslinked functional groups, for example less than about 0.5 mol percent, up to about 0.3 mol percent, or from about 0.1-0.3 mol percent.

The silicone polymer may be in the form of a “silicone gum”, this term being defined herein as a substantially uncrosslinked silicone polymer which is substantially free of conventional fillers. Examples of conventional fillers include reinforcing fillers such as amorphous fumed silicas or precipitated silicas, which are typically added to silicones to improve strength. These fillers are typically added in amounts of about 30 wt. % to produce conventional silicone base compositions.

The inventors have found that it may not be possible to achieve a sufficiently high loading of varistor particles where the varistor particles are added to a conventional silicone base composition containing about 30 wt. % fumed silica. Therefore, in some embodiments of the invention, the varistor particles are incorporated into a silicone gum which is completely or substantially free of any reinforcing fillers. That is not to say, however, that the polymer matrix will be completely free of fillers in the finished stress control material. For example, where the varistor particles are added to a silicone gum up to the required loading level, there are situations where it is advantageous to add an amount of reinforcing filler. For example, if the varistor-filled silicone gum has flowability which is too high, it may be desired to add an amount of reinforcing filler such as fumed silica or other suitable rheological modifiers to bring the flowability into a desired range. A wide range of rheology modifiers are commercially available and known to those skilled in the art.

The silicone polymers used herein typically have a molecular weight ranging from about 370,000 to 740,000 and a degree of polymerization (i.e. the average number of repeating units in the polymer molecules) ranging from about 5,000 to 10,000.

In some embodiments of the invention, the silicone polymer is used as a “neat” silicone or polysiloxane polymer, and the repeating units in the polymer molecules making up the gum consist essentially of polydimethylsiloxane repeating units with a negligible amount of crosslinkable functional groups such as vinyl groups, for example less than about 1 mol percent of crosslinked functional groups, less than about 0.5 mol percent, up to about 0.3 mol percent, or from about 0.1-0.3 mol percent.

In the stress control materials according to the invention, the polymer matrix is loaded with relatively large amounts of the particulate filler described above. For example, on a weight basis, the amount of filler embedded in the polymer matrix ranges from about 60-90 wt %, for example about 70-85 wt %, or about 75-80 wt %, based on the total weight of the stress control material. In terms of weight ratios, the weight ratio of particulate filler to polymer matrix is greater than about 2:1, and may for example be greater than about 3:1, and/or up to about 4:1. At a filler content of about 4:1 the stress control material may have a specific gravity in the range from about 2.65-2.71 g/cm³.

The inventors found that filler loading at the above levels is either not possible with conventional silicone base polymer compositions containing reinforcing fillers such as fumed silica in amounts up to 30 wt % or, alternatively,produces stress control materials having poor void-filling properties. In contrast, the polymer matrix according to the invention is able to accept considerably larger amounts of particulate fillers while maintaining its void-filling properties.

Specific examples of cable joints and terminations are now discussed below with reference to the drawings.

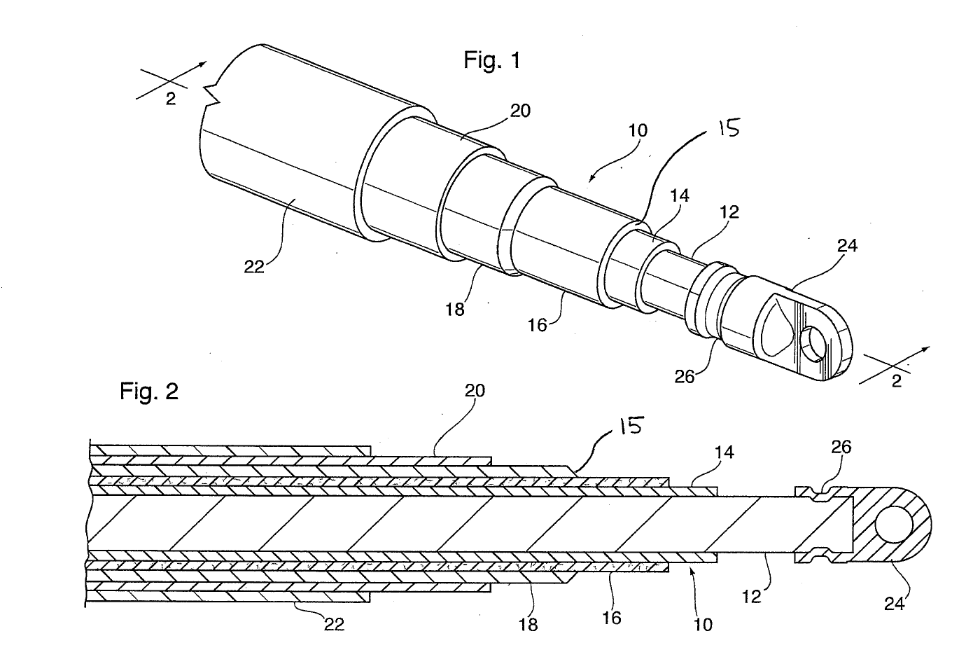

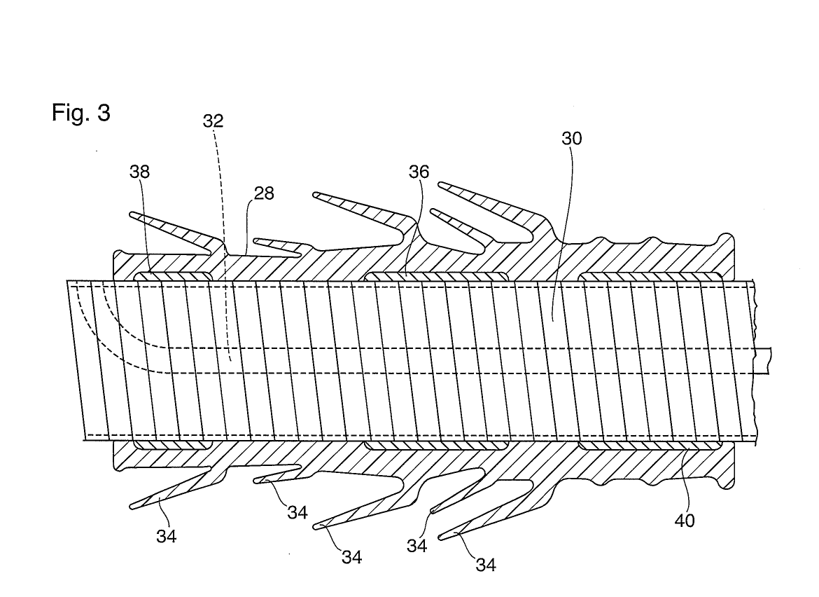

FIGS. 1 and 2 schematically illustrate one end of a medium voltage electrical cable 10, the end having been prepared for termination and ready to accept a stress control article according to the invention. The cable 10 comprises a plurality of layers, comprising (from the inside out): a metal conductor 12 typically comprising copper; a semi-conductive conductor screen 14; an insulating layer 16; a semi-conductive insulation screen 18; a conductive screen 20 comprising copper wires or a helically wound copper tape; and an outer plastic sheath 22. To prepare the termination, each layer is cut back to expose an end portion of the layer below it. As mentioned above, electrical stresses tend to concentrate at the end of the semi-conductive insulation screen 18, and the cut end face 15 of this layer is typically formed with a chamfer, as seen in FIG. 2. The end of the conductor 12 is inserted into the hollow end of a conductive metal lug 24, and the lug 24 is crimped to the conductor 12 at 26. Although the drawings show a cable having a specific layered structure, it will be appreciated that the stress control articles according to the invention are not restricted to use with a specific cable structure. To the contrary, the stress control articles according to the invention can be used with cables having alternate layered structures in which stress control is required.

FIG. 3 illustrates a cold shrink sleeve 28 for protection of a medium voltage cable termination, such as that illustrated in FIGS. 1 and 2. The sleeve 28 comprises an elastomeric, electrically insulating material such as silicone rubber. The sleeve 28 is stretched to a first diameter greater than an outside diameter of the cable 10, and maintained in the expanded state by a one-piece rigid spiral core 30, one end of which forms a pull tab 32 by which the core 30 is removed from sleeve 28. The sleeve 28 may have a thickness of about 5 mm, and may have an outer surface provided with a plurality of rain shields 34.

The inner surface of sleeve 28 is provided with a layer of a stress control material 36 as defined above, the stress control material 36 being applied over an area of the inner surface which will be in contact with the areas where stresses are concentrated, such as the areas surrounding the cut end face 15 of the semi-conductive insulation screen 18 when the sleeve 28 is applied to a cable 10. The thickness of this layer will be sufficient that the stress control material 36 completely fills the radial step formed at the cut end face 15 of the semi-conductive insulation screen 18. In an exemplary embodiment, where the cable 10 is a 25 kV medium voltage cable, the layer of stress control material 36 has a thickness of about 1 mm and a length (measured along the longitudinal axis of sleeve 28) of about 100 mm, wherein the thickness and length are measured before application of the sleeve 28 to the cable 10. It is possible to extend the layer of stress control material 36 over a greater area of the sleeve inner surface, however this may not be cost effective.

The inner surface of sleeve 28 may also be provided with one or more layers of a conformable water sealing mastic. In the illustrated embodiment, two such layers are provided, labeled in the drawings as 38 and 40. The mastic layers 38 and 40 are located at opposite ends of the sleeve 28 and seal the ends of the sleeve 28 against ingress of moisture. It will be appreciated that layer 38 is optional. The water sealing mastic may comprise a silicone polymer which may comprises a silicon base polymer as described above.

In use, the sleeve 28 as illustrated in FIG. 3 is applied over the end of cable 10, which has been prepared as shown in FIGS. 1 and 2. The sleeve 28 is positioned on the end of cable 10 such that the mastic layer 40 at one end is positioned over lug 24 and the connecting portion of lug 24 protrudes out from the end of the sleeve 28. The mastic layer 38 at the other end of sleeve 28 is positioned over the outer sheath 22 of cable 10. The layer of stress control material 36 is positioned over the cut end face 15 of the semi-conductive insulation screen 18 and extends in both directions from the cut end face 15.

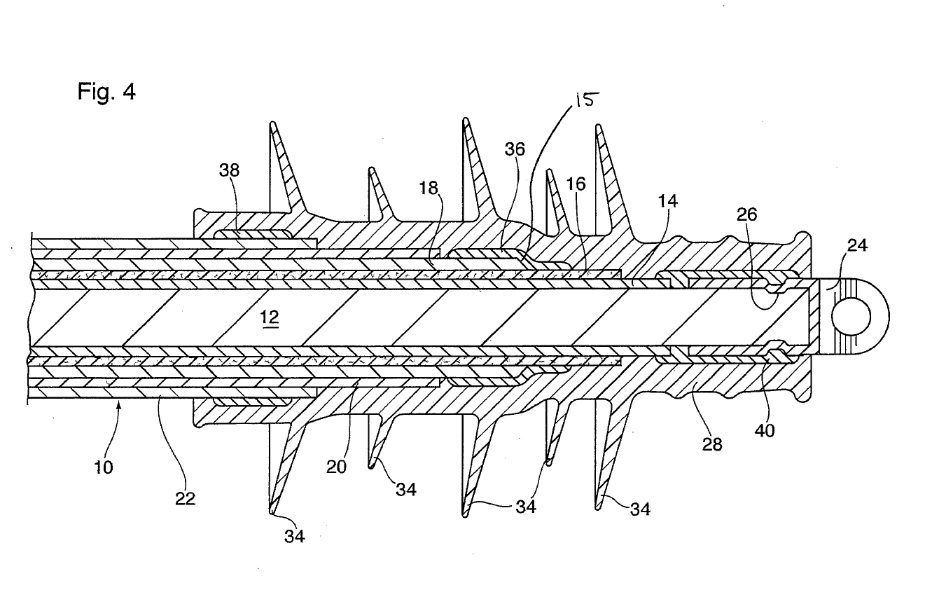

With the sleeve 28 in position over the end of cable 10, the core 30 is pulled out from the inside of sleeve 28, and the sleeve 28 recovers its original, unstretched shape. The original diameter of the sleeve 28 will be somewhat less than the outside diameter of the cable 10 such that the sleeve 28 will “shrink” radially into intimate contact with the outer surface of cable 10 along the entire length of the termination. Simultaneously, the layer of stress control material 36 and the mastic layers 38, 40 are brought into intimate contact with the cable 10. The mastic layers 38, 40 are sufficiently compliant such that they will effectively seal the ends of the sleeve 28. The layer of stress control material 36 is sufficiently flowable that it will completely fill the radial step or chamfer at the cut end face 15 of the semi-conductive insulation screen 18, and such that it will completely fill any defects such as nicks or cuts in or near the cut end face 15 of the semi-conductive insulation screen 18. FIG. 4 shows the sleeve 28 applied to cable 10, after the core 30 is removed and recovery (i.e. by cold shrinking) is complete.

The inventors have found that the stress control material 36 is sufficiently flowable to displace any residual air located in pockets, micro-voids or other defects in the vicinity of the cut end face 15 of the semi-conductive insulation screen 18. These defects can be caused by lack of care in preparing the cable termination. The inventors believe that the presence of residual air in these defects will permit electrical discharges to occur at or near to the cut edge of the cut end face 15 of the semi-conductive insulation screen 18, which may result in degradation in the insulation layers of the cable 10.

The flowability of the stress control material 36 permits it to fill and displace residual air from any defects such as pockets or micro-voids. Furthermore, the stress control material 36 is permeable to air, and the inventors believe that the displaced air will be absorbed and dissipated within the layer of stress control material 36, thereby avoiding the risk of damage to the insulation of cable 10. The inventors believe that the gradual displacement of air from pockets and micro-voids after application of the sleeve 28 is demonstrated by an observed increase over time in the voltage at which partial discharge in the termination is initiated.

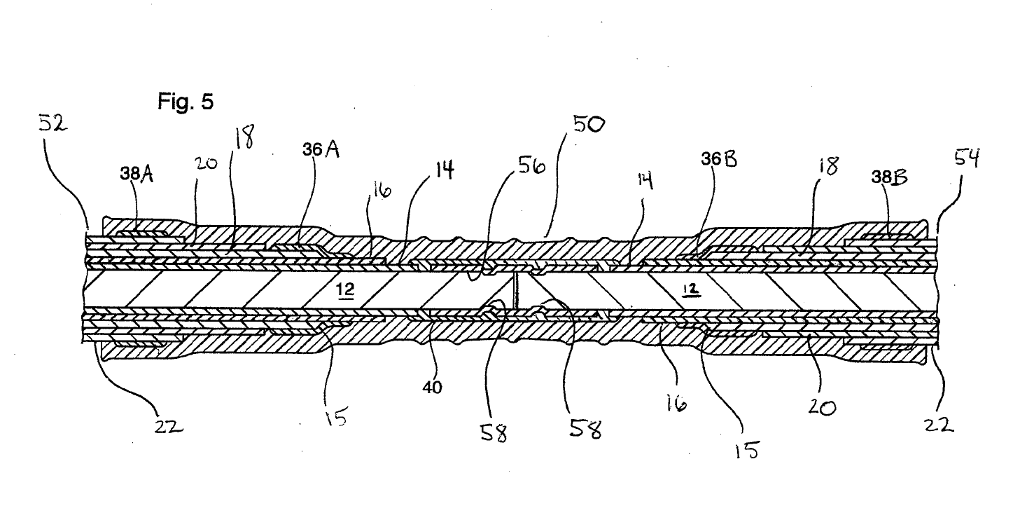

FIG. 5 illustrates a second embodiment of the invention, namely a sleeve 50 for application to a joint between the ends of two medium voltage cables 52, 54. For the purpose of this discussion, it will be assumed that the ends of the two cables 52, 54 are prepared in the same way as the termination in cable 10 described above. Therefore the various layers making up cables 52, 54 are described using like reference numerals, and the above description of the like components of cable 10 applies equally to cables 52, 54. Similarly, the sleeve 50 has many features in common with the sleeve 28. Accordingly, like components of sleeves 28, 50 are described using like reference numerals, and the above description of the like components of sleeve 28 applies equally to sleeve 50. The following description will focus on differences between sleeves 28 and 50 and the cables to which they are applied.

The end of each cable 52, 54 is prepared by cutting back each successive layer 14, 15, 18, 20, 22 of the jacket to expose an end portion of the layer below it, and to expose the bare end of the conductor 12, in the same manner as described above with reference to cable 10. However, instead of a metal lug 24, there is provided a metal connector 56, which may have a cylindrical shape, and which has first and second hollow ends to receive the bare ends of conductors 12. The conductors 12 may be retained in connector 56 by crimping, as indicated at 58 in FIG. 5, but may instead be retained by alternate means such as by set screws, or soldering.

The sleeve 50 has the same or similar construction and composition as sleeve 28. For example, where sleeve 50 is cold-shrinkable, it may be stretched to a first diameter greater than an outside diameter of cables 52, 54, and maintained in the expanded state by a one-piece rigid spiral core 30 (not shown). The inner surface of sleeve 50 is provided with two layers of stress control material, labeled 36A and 36B, one for each cable 52, 54. In particular, the first layer of stress control material 36A will be in contact with the area surrounding the cut end face 15 of semi-conductive insulation screen 18 of cable 52, while the second layer of stress control material 36B will be in contact with the area surrounding the cut end face 15 of semi-conductive insulation screen 18 of cable 54. The thickness and length of layers 36A and 36B may be the same as layer 36 of sleeve 28, described above.

The inner surface of sleeve 50 may also be provided with one or more layers of a conformable water sealing mastic, labeled in the drawings as 38A and 38B. The first layer of mastic 38A is positioned over the outer sheath 22 of cable 52 and the second layer of mastic 38B is positioned over the outer sheath of cable 54. The inner surface of sleeve 50 is also shown as having a second layer 40 of conformable water sealing mastic, surrounding the connector 56.

The sleeve 50 is slid over one of the cables 52 or 54 before both conductors 12 are secured to the connector 56. Once the conductors 12 are joined to connector 56, the sleeve 50 is moved into position over the joint area and the core 30 (not shown) is removed, causing the sleeve to shrink radially into contact with the cables 52, 54 and connector 56, as shown in FIG. 5.

The invention is further illustrated by the following Examples.

### EXAMPLE 1

This example compares the electrical properties of a stress control material according to the invention with conventional stress control materials.

The same ZnO microvaristor having the properties set out in the above description was blended in three different carriers to a level of 80 wt %. The polyolefin carrier (ethylene vinyl acetate) needed to be heated in order to accept ZnO microvaristor. The competitive material was of unknown composition but is believed by the inventors to comprise ethylene vinyl acetate. The silicone gum was a liquid at room temperature and did not require heat to accept the ZnO microvaristors. The silicone gum consisted essentially of a polydimethylsiloxane polymer including less than about 1 mol percent of crosslinkable functional groups, having a molecular weight ranging from about 370,000 to 740,000 and a degree of polymerization ranging from about 5,000 to 10,000.

After compounding / blending, plaques of the material were made and tested for electrical properties in accordance with applicable ASTM test methods.

TABLE 1
Electrical Properties of Stress Control Materials

| | Dielectric | Dissipation | Volume Resistivity |
|---|---|---|---|
| | Constant (DC) | Factor (DF)/% | (VR)/ohm-cm |
| ZnO in Silicone | 8 | 0.04 | >1.00 × 10¹⁵ |
| Gum | | | |
| ZnO in Polyolefin | 9.5 | 2.28 | >1.00 × 10¹⁴ |
| Carrier | | | |
| ZnO in Competitive | 7.3 | 2.5 | >1.00 × 10¹⁴ |
| Material | | | |

The dielectric constant (DC) needs to be sufficiently high to show conductive properties for stress grading capability. The volume resistivity (VR) needs to be sufficiently high to demonstrate insulation properties, and the dissipation factor (DF) needs to be sufficiently low as it indicates minimal waste of electrical energy as heat. As shown by the test results, the stress control material according to the invention, comprising ZnO in silicone gum, had a DF about two orders of magnitude lower, and a VR about one order of magnitude higher, than the comparative materials, and had an acceptably high DC which was between the DC values for the comparative samples.

### EXAMPLE 2

This example compares the electrical performance of a stress control material according to the invention with conventional stress control materials in a medium voltage cable termination.

In this example, a stress control material according to the invention as described in Example 1 was prepared as a film and applied to the inner surface of a low voltage (LV) cold shrink sleeve (Sample 1) and to the inner surface of a medium voltage (MV) cold shrink sleeve (Sample 2). The MV sleeve is made of a higher grade material and is thicker than the LV sleeve. The electrical performance of these samples was compared with that of a commercially available shrink product (Sample 3) comprising a cold shrink silicone sleeve having an inner surface provided with a geometric stress grading technology comprising carbon black in a silicone carrier, with the geometric stress grading being directly injection molded into the silicone sleeve in a cone shape. All samples were tested for partial discharge on a 15 kV medium voltage cable in accordance with the IEEE standard for terminations, i.e. electrical discharge of <3 pC at an inception voltage of 22 kV for a 25 kV termination. The tests measured the inception voltage at which the electrical discharge remains at <3 pC. The inception voltage is the voltage at which one starts to see partial discharge in the termination.

TABLE 2
Electrical Performance of Stress Control Materials

| | | Inception | Inception | Inception | Inception |
|---|---|---|---|---|---|
| | | Voltage | Voltage | Voltage | Voltage |
| | | at 0 | at 1 | at 30 | at 60 |
| Sample | Composition | hrs/kV | day/kV | days/kV | days/kV |
| 1 | ZnO with LV | 17.5 | 35 | 35 | 35 |
| | Sleeve | | | | |
| 2 | ZnO with MV | 21.5 | 30 | 30 | 30 |
| | Sleeve | | | | |
| 3 | Existing | 15 | 23 | — | — |
| | Geometric | | | | |
| | Stress | | | | |
| | Grading | | | | |

As the cold shrink sleeve needs time to fully recover and provide constant force down upon the termination, and in particular at the cutback of the semi-conductive shield, a significant increase in the inception voltage after 1 day was observed for all samples. No further increase in the inception voltage was observed for Samples 1 and 2 after 1 day, although the inception voltages after 1 day for Samples 1 and 2 were observed to be greater than the inception voltage of Sample 3, indicating superior electrical performance.

Although the invention has been described in connection with specific embodiments and examples, it is not intended to be limited thereto. Rather, the invention includes all embodiments which are within the scope of the claims.

What is claimed is:

1. A stress control article for an electrical cable, wherein the stress control article comprises:
(a) a cover layer comprised of an electrically insulating, flexible polymeric material; and
(b) a stress control layer applied to one side of the cover layer, wherein the stress control layer comprises a stress control material, and the stress control material comprises:
(i) a particulate filler comprising varistor particles;
(ii) a polymer matrix in which the particulate filler is embedded, wherein the polymer matrix comprises a silicone gum.

2. The stress control article according to claim 1, wherein the silicone gum is a non-tacky, flowable silicone polymer comprised of siloxane repeating units having the general formula [—O—Si(R₂)—], wherein each R group is independently selected from the group comprising alkyl groups, alkenyl groups and aryl groups, any of which may be substituted or unsubstituted.

3. The stress control article according to claim 2, wherein the alkyl groups are selected from the group comprising methyl, ethyl and propyl groups, any of which may be substituted or unsubstituted.

4. The stress control article according to claim 2, wherein the alkenyl groups comprise substituted or unsubstituted vinyl groups.

5. The stress control article according to claim 2, wherein the aryl groups comprise substituted or unsubstituted phenyl groups.

6. The stress control article according to claim 2, wherein the silicone gum is substantially free of crosslinks.

7. The stress control article according to claim 2, wherein the silicone gum comprises less than about 1 mol percent of crosslinkable functional groups.

8. The stress control article according to claim 7, wherein the silicone gum comprises less than about 1 mol percent of said alkenyl groups.

9. The stress control article according to claim 2, wherein said R groups consist essentially of methyl groups, such that the silicone gum consists essentially of a polydimethylsiloxane polymer.

10. The stress control article according to claim 2, wherein the repeating units in the polymer molecules making up the gum consist essentially of polydimethylsiloxane repeating units.

11. The stress control article according to claim 2, wherein the silicone gum has a molecular weight ranging from about 370,000 to 740,000 and a degree of polymerization ranging from about 5,000 to 10,000.

12. The stress control article according to claim 1, wherein the amount of the particulate filler embedded in the polymer matrix ranges from about 60-90 wt. %.

13. The stress control article according to claim 1, wherein the weight ratio of the particulate filler to the polymer matrix in the stress control material is from about 2:1 to about 4:1.

14. The stress control article according to claim 1, wherein the varistor particles comprise doped particles of ZnO.

15. The stress control article according to claim 14, wherein the varistor particles have an average particle size of less than about 80 μm.

16. The stress control article according to claim 1, wherein the cover layer is a cold shrink tube, wherein the electrically insulating, flexible polymeric material of the cover layer comprises an elastomeric material, and wherein said one side of the cover layer to which the stress control layer is applied is an inner surface of the tube.

17. The stress control article according to claim 16, wherein the elastomeric material comprises silicone rubber.

18. The stress control article according to claim 16, wherein the stress control article further comprises a removable, one-piece rigid spiral core received inside the cover layer, wherein the cover layer is maintained in a stretched state by the core.

19. The stress control article according to claim 1, wherein the stress control layer is applied over portions of the inner surface which, when the article is installed over a cable, will be in contact with those portions of a cable termination or joint which are subjected to the greatest electrical stresses.

20. The stress control article according to claim 16, wherein the cold shrink tube has two ends, and wherein each end of the tube is provided with a layer of a conformable water sealing mastic, wherein the layers of the conformable water sealing mastic are applied to the inner surface of the tube.
